(19) United States
(12) Patent Application Publication
(10) Pub. No.: US 2002/0094399 A1
(43) Pub. Date: Jul. 18, 2002

(54) Article having inwardly projecting ribs

(75) Inventors: Richard D. Rhodes JR., Somersworth, NH (US); Tony C. Dahm JR., Sterling Heights, MI (US)

Correspondence Address: Hayes, Soloway, Hennessey, Grossman & Hage, PC, 175 Canal Street, Manchester, NH, 03101, US

(73) Assignee: McCord Winn Textron

(21) Appl. No.: 09/766,319

(22) Filed: Jan. 16, 2001

(51) Int. Cl. B65D 6/40; B32B 31/00; B29D 22/00; B29D 9/00

(52) U.S. Cl. 428/36.9; 215/12.1; 264/516; 156/213; 156/73.1; 428/36.91

(57) ABSTRACT

A blow molded article comprising an inwardly projecting rib and a mold loose piece, the inwardly projecting rib comprising a wall portion formed around an inwardly projecting mold loose piece. In method form, the present invention relates to a blow molded article having at least one inwardly projecting rib, the method comprising the steps of providing a mold having a cavity defined therein by a cavity wall, providing a mold loose piece disposed on the cavity wall, introducing a parison into the cavity, and introducing the mold loose piece into the parison.

### FIELD OF THE INVENTION

The present invention relates to a hollow container having an inwardly projecting rib structure, and more particularly to a hollow container having a separately formed internally projecting rib structure integrally molded with the container.

### BACKGROUND OF THE INVENTION

U.S. Pat. No. 6,060,144 discloses a hollow blow molded panel formed having an internally projecting double walled rib. The double walled rib is formed using a sliding core member disposed in a first mold half. With a parison disposed in a mold, the sliding core member is inserted into the mold cavity, therein causing one portion of the parison wall to protrude inwardly until it contacts an opposing portion of the parison wall, whereupon the protruding portion of the parison wall becomes integrally bonded to the opposing portion of the parison wall. The sliding core member is then retracted into the first mold half. When the parison is inflated, the parison is forced to conform to the geometry of the mold, and the exterior portions of the protruding parison wall are forced together forming a double walled rib.

U.S. Pat. No. 4,170,622 discloses two methods of forming a blow molded article having a ribbed interior surface. The first method disclosed by the '622 patent comprises a two-step process for forming a blow molded article having a ribbed interior surface. The first step of the process comprises forming pre-form using a mold having inwardly projecting convex features, therein forming a part having inwardly projecting grooves. The pre-form is then transferred to a final mold that does not contain rib features. When the pre-form is expanded in the final mold, the inwardly projecting grooves of the pre-form collapse and fuse forming an inwardly projecting, folded rib.

The second method taught by the '622 patent utilizes moving core portions of the mold corresponding to the desired ribs. The parison is initially expanded with the core portions protruding into the cavity of the mold, therein forming inwardly projecting grooves in the expanded parison. The core portions are then retracted, and the parison is further expanded, therein collapsing the grooves and forming an inwardly projecting fold, i.e., a rib.

Another method of forming a blow molded article having inwardly projecting ribs is disclosed in U.S. Pat. No. 4,151,249. The method disclosed in the '249 patent employs a parison comprising a major portion having a first modulus of elasticity containing strips having a modulus of elasticity that is greater than the modulus of elasticity of the major portion. When the parison is expanded within the mold, the major portion expands more rapidly than the strips having a higher modulus of elasticity, therein creating grooves in the article. Upon further expansion the grooves in the article collapse together, therein forming internally projecting ribs in a manner similar to the '622 patent discussed above.

### SUMMARY OF THE INVENTION

A blow molded article comprising at least one inwardly projecting rib, wherein the rib is a composite structure comprising wall portion and a mold loose piece around which the wall is shaped to form the rib. In a second embodiment, the mold loose piece at least partially penetrates the wall portion, the adjacent regions of the wall portion being formed around the base of the mold loose piece.

According to another aspect of the present invention, a blow molded article is provided comprising at least one inwardly projecting rib, wherein the at least one inwardly projecting rib serves to partition or section off the blow molded article. Furthermore, the at least one inwardly projecting rib is a composite structure comprising a wall portion formed around a mold loose piece. In an alternate embodiment, the blow molded article comprises at least one internal partition, wherein the at least one partition comprises at least two inwardly projecting ribs, the inwardly projecting rib being joined together in the interior of the blow molded article.

According to yet another aspect of the present invention, a method for forming a blow molded article is provided, the method comprising providing a mold having a mold loose piece corresponding to the geometry of the desired rib. A parison or pre-form is introduced into the mold, whereupon the mold is closed and the parison or pre-form is inflated. The inflation pressure provided is preferably sufficient to force the exterior of the parison or pre-form to conform to the geometry of the mold cavity and to the geometry of the mold loose piece, the mold loose piece being retained with the article after molding.

### BRIEF DESCRIPTION OF THE DRAWINGS

Exemplary embodiments of the invention are set forth in the following description and shown in the drawings, wherein:

FIG. 1 illustrates, in cross-sectional view, an exemplary container consistent with the present invention;

FIG. 2 illustrates, in cross-sectional view, a first exemplary embodiment of a mold for manufacturing a container consistent with the present invention;

FIG. 3 illustrates, in cross-sectional view, a second exemplary embodiment of a mold for manufacturing a container consistent with the present invention;

FIG. 4 depicts a first exemplary embodiment of a mold loose piece in cross-sectional view;

FIG. 5 is a cross-sectional view of a second exemplary embodiment of a mold loose piece;

FIG. 6 is a cross-sectional view of an exemplary embodiment of a free standing rib consistent with the present invention;

FIG. 7 illustrates, in cross-sectional view, an exemplary embodiment of a single rib partitioned container consistent with the present invention;

FIG. 8 illustrates, in cross-sectional view, a second exemplary embodiment of a single rib partitioned container consistent with the present invention;

FIG. 9 is a cross-sectional view of an exemplary tongue and groove partition consistent with the present invention;

FIG. 10 is a cross-sectional view of a second exemplary double rib partition consistent with the present invention.

### DETAILED DESCRIPTION OF THE INVENTION

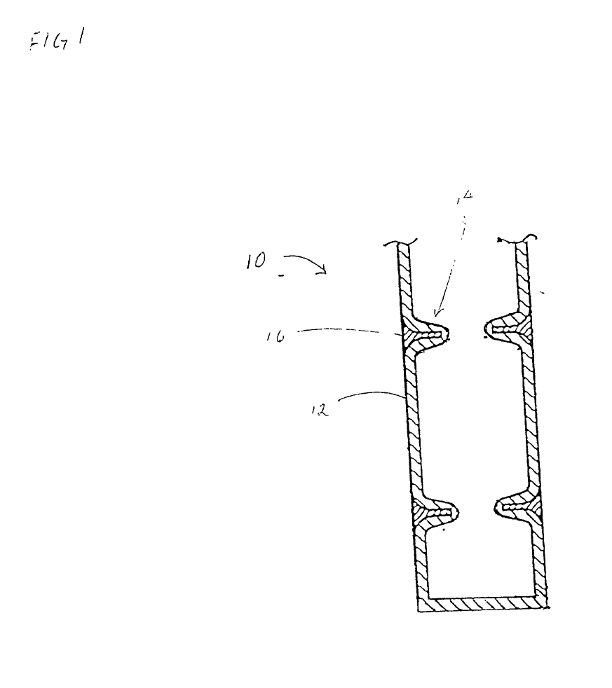

With reference to FIG. 1, an exemplary embodiment consistent with the present invention is illustrated in cross-sectional view comprising a “hot,” or pressurized container 10 for use with an automotive coolant system. The pressurized container 10 comprises a wall 12 having at least one rib 14 projecting into the interior of the container 10. The inwardly projecting rib 14 itself comprises a mold loose piece 16 and a portion of the wall 12 formed around the mold loose piece 16. The mold loose piece 16 is a piece that originally is on the mold itself, but becomes part of the final blow molded product. It will be appreciated that the inwardly projecting rib 14 consistent with the present invention may be employed on any hollow blow molded article.

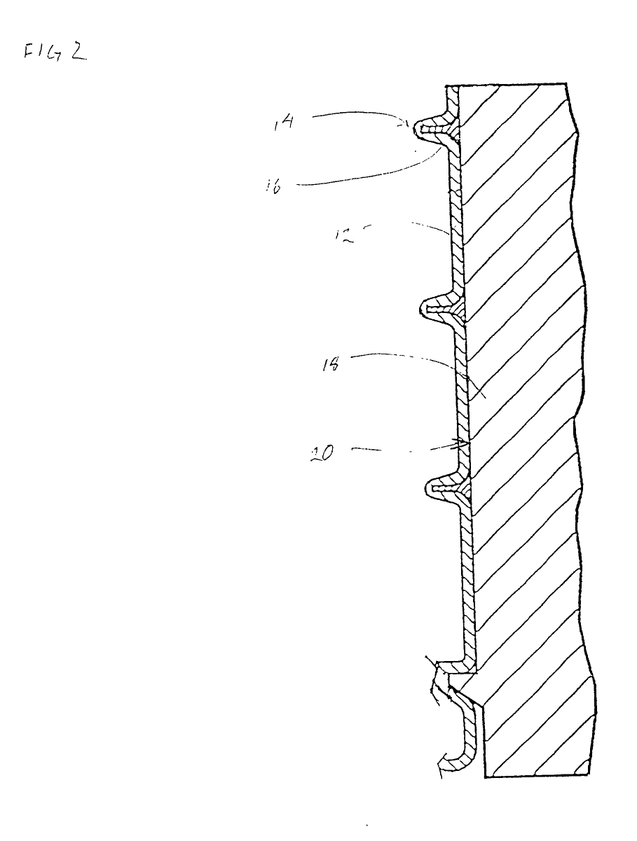

Internally projecting ribs 14 consistent with the present invention are preferably formed by providing a mold loose piece 16 disposed in the mold 18 during the blow molding process. In a first exemplary embodiment, illustrated in FIG. 2, the mold loose piece 16 is positioned on the mold cavity wall 20 such that when the mold 18 is closed around the parison or pre-form, and the parison is inflated, the expanding parison conforms to, and is tightly pressed against, the mold loose piece 16. The mold loose piece 16 may be maintained in position on the mold cavity wall 20 by such means as a shallow recess in the face of the mold cavity wall 20, or simply by the geometric restrictions of the cavity shape. Alternate means for retaining the mold loose piece 16 may include a weak adhesive, retractable dowel pins, non-retractable dowel pins, frangible mechanical fasteners, etc. The mold loose piece 16 remains with the blow molded container 10, preferably integral with the wall 12 of the container 10. The finished container 10, therefore contains a composite rib 14 comprising the mold loose piece 16 and the wall 12 of the blow molded container 10.

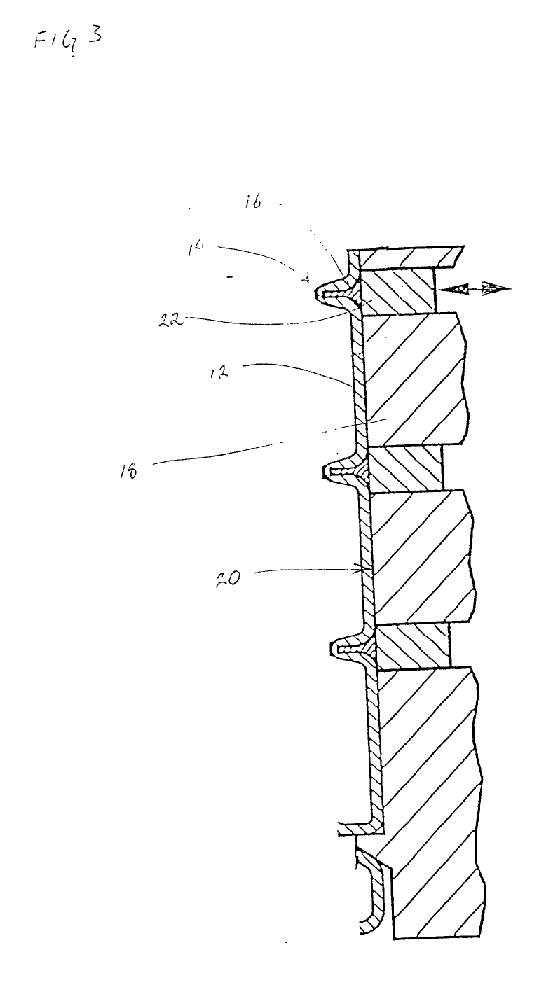

In a second preferred embodiment, illustrated in FIG. 3, a container 10 having inwardly projecting ribs 14 may be manufactured using moving tool components, such as slide actions. According to the second embodiment, the mold loose piece 16 is maintained in an at least partially retracted configuration within the mold 18. The positioning of the mold loose piece 16 in the mold cavity corresponds to the location of a moveable slide feature 22 in the mold. After the parison, or pre-form, has been introduced into the mold 18, and the mold halves have closed, the movable slides 22 act to insert the mold loose piece 16 into the parison, before, during, or after inflation of the parison. If required, the mold loose piece 16 may be maintained in position within the mold cavity 18 in any manner similar to those discussed according to the first embodiment above.

In either of the above embodiments, the temperature of the mold loose piece 16 may be controlled to better facilitate attachment to the blow molded parison. Furthermore, by controlling the temperature of the mold loose piece 16, it may be possible to regulate the draw characteristics of the parison as it stretches and forms over the mold loose piece 16. For example, if the mold loose piece 16 is heated to a temperature proximate to the parison temperature, it may be possible to limit or avoid freezing of the parison on contact with the mold loose piece 16. A reduction in contact freezing of the parison may not only enhance parison/mold loose piece fusion, but may better allow the parison to conform to mechanical lock features present on the mold loose piece 16, therein achieving a more secure attachment of the mold loose piece.

The mold loose piece 16 preferably comprises a plastic material, and more preferably comprises the same, or a similar material, as that used to form the wall 12 of the container. Suitable but by no means limiting plastic material for either the mold loose piece or parison include all thermoplastic resins suitable for blow-molding, such as polyolefin resins (polyethylene and/or polypropylene). More specifically, high-density polyethylene (HDPE), linear-low density polyethylene (LLDPE), low-density polyethylene (LDPE), metallocene based polyethylene, and polyethylene copolymers. In addition, thermoset resins may be employed for either the mold loose piece or parison. However, in the case of a thermoset resin employed for a parison, the resin must be one that allows shaping into a parison form, prior to extensive crosslinking and the development of a non-plasticating condition.

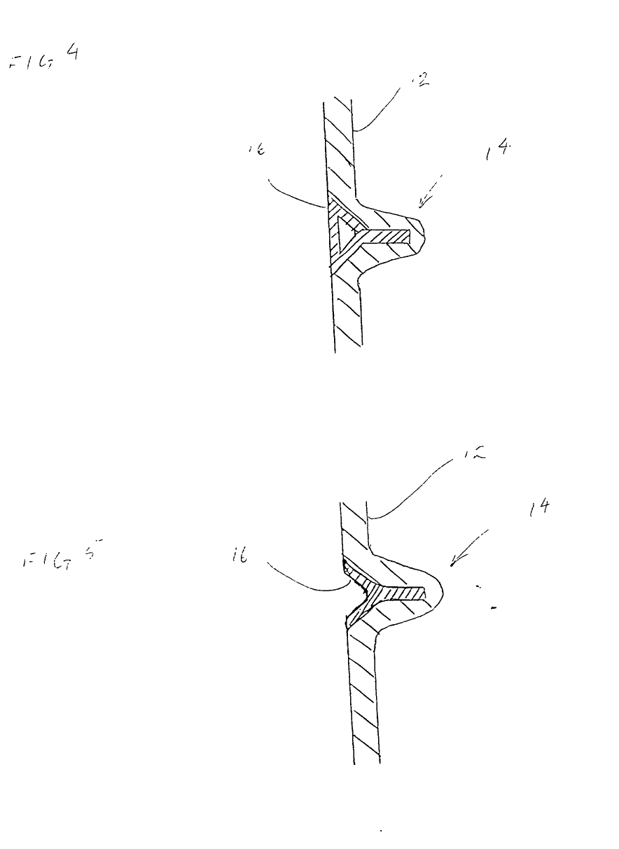

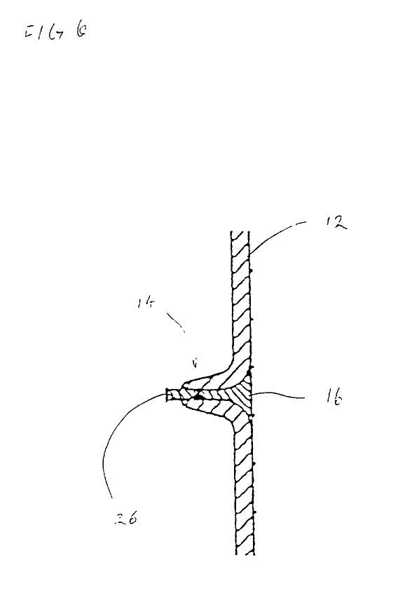

Alternately, the mold loose piece may comprise any material capable of being shaped to the desired geometry, for example, a metallic material. The mold loose piece 16 may be formed in any configuration corresponding to the desired inwardly projecting rib 14. Additionally, the mold loose piece 16 may comprise a solid section, or alternately may comprise a hollow feature or an open feature, as shown in cross section in FIGS. 1, 4 and 5 respectively. The mold loose piece 16 may be manufactured by processes including, but not limited to, profile extrusion, injection molding, thermoforming, or blow molding.

To fully realize the benefits of the inwardly projecting rib structure 14 according to the present invention, it is desirable that the mold loose piece 16 is securely retained to the wall 12 of the container 10. The mold loose piece 16 may be secured to the wall 12 of the container 10 using a multitude of techniques. In a first embodiment, the thermal properties, that is the glass transition temperature, melt temperature and tack temperature and characteristics, of the material of the container wall 12 and the material of the mold loose piece 16 are coordinated such that, when the parison is inflated and forced into contact with the mold loose piece 16, the container wall 12 and the mold loose piece thermally bond about a substantial portion of the interface. Alternately, an adhesive may be employed at the interface of the container wall 12 and the mold loose piece 16 to bond the components to one another. The adhesive may comprise a thermally activated adhesive applied to the mold loose piece 16 prior to molding, wherein the adhesive is activated by the heat from the parison. Suitable heat-activated adhesives include those polymer resins which, upon heat, further polymerize and/or crosslink to provide adhesion between two surfaces. Alternatively, one could locate a thermoplastic adhesive film (e.g., poly(vinylalcohol)) located between the mold loose piece and the container wall that will melt between the two surfaces and bind the surfaces together and also serve as a barrier resin layer. One could also make use of pressure-sensitive adhesives, which typically comprise an elastomeric resin (e.g. diene rubbers) and tackifiers. In addition, one could make use of reactive adhesives, e.g., a two-part system made up of a base resin (such as epoxy) and a catalyst, which mix and polymerize to form a thermoset plastic.

In yet another embodiment, the mold loose piece 16 may comprise mechanical features, such as surface roughening, graining, undercuts, holes, etc., that will form a mechanical lock between the mold loose piece 16 and the container wall 12 when the parison is inflated and forced to conform to the mechanical features.

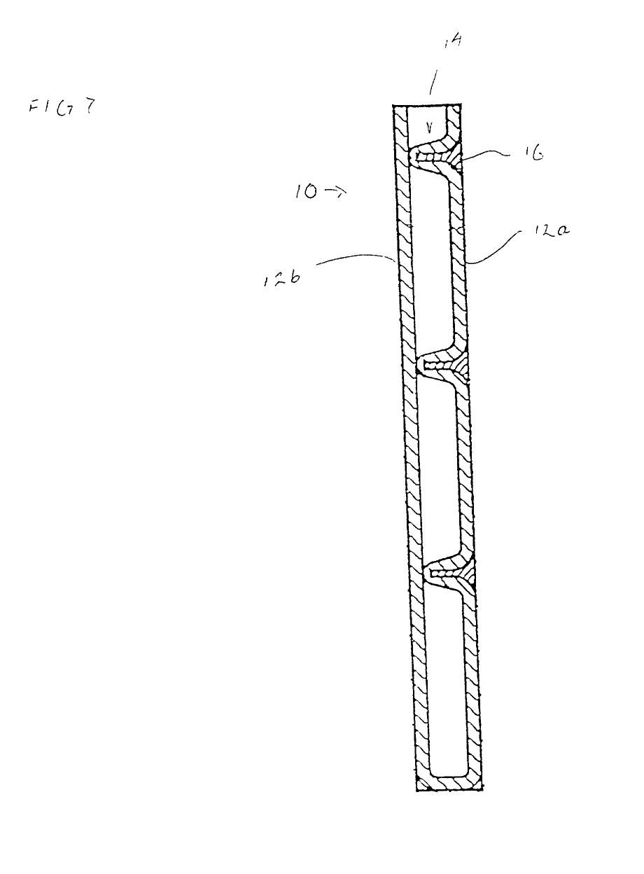

As illustrated in FIGS. 1 and 6 through 10, inwardly projecting ribs consistent with the present invention may be employed in a variety of configurations and combinations of configurations. As shown in FIG. 1, the rib 14 may simply comprise an inwardly projecting freestanding structure comprising a wall section 12 deformed around a mold loose piece 16. With reference to FIG. 6, and alternate embodiment of a freestanding rib 14 may comprise a mold loose piece 16 having an inwardly projecting portion, wherein the inwardly projecting portion of the mold loose piece 16 has not only inwardly deformed the wall 12, but has penetrated at least a portion of the wall 12, such that the distal end 26 of the mold loose piece 16 extends through the wall 12. In the case of a penetrating mold loose piece 16, the inflation of the parison preferably causes it to form around, and seal to, the base of the mold loose piece 16, therein maintaining the integrity of the container 10. The integrity of the container 10 may be further ensured by employing an adhesive or mechanical feature, such as groove in the mold loose piece 16, adjacent the region of penetration.

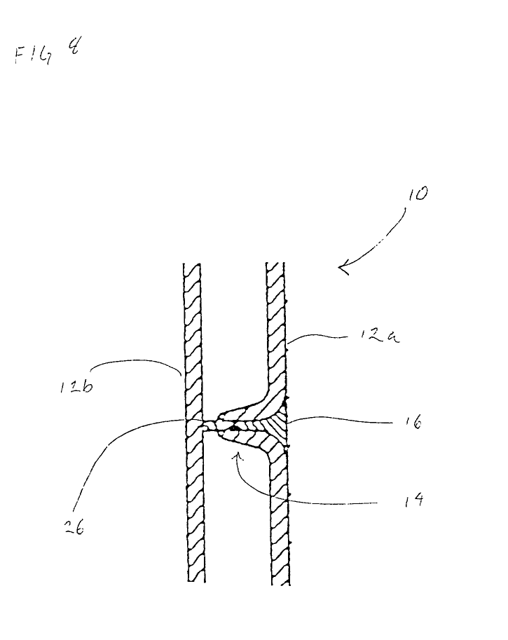

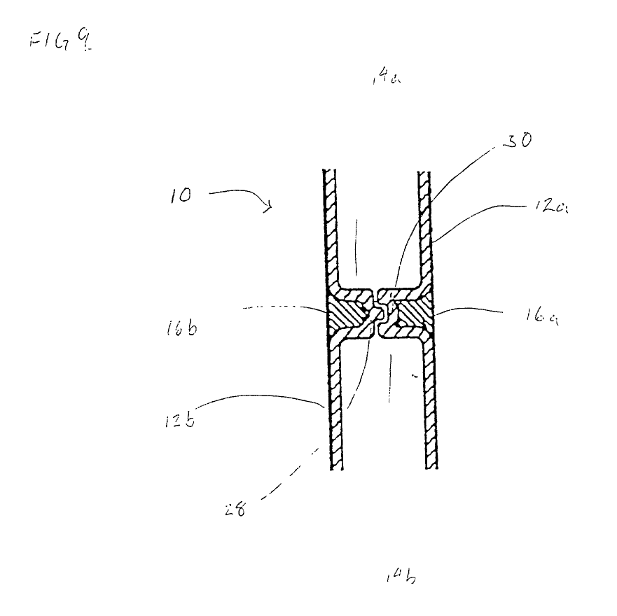

In addition to an inwardly projecting free standing rib, a rib 14 consistent with the present invention may be configured to extend across at least a portion of the container 10, as shown in FIGS. 7 through 10. Ribs 14 that are configured to span the container 10 may be configured to provide enhanced crush resistance and/or burst resistance. Alternately, ribs 14 spanning the interior of the container 10 may be employed to partition or section off the container 10. In a first exemplary embodiment, illustrated in FIG. 7, the rib 14 extends from a first wall 12a across the container 10 to a second, opposing wall 12b. With reference to FIG. 8 a second exemplary embodiment is illustrated, wherein the rib 14 comprises a mold loose piece 16 that has penetrated a first wall 12a, and further wherein at least a portion of the mold loose piece 16 which has penetrated the wall 12a contacts the opposing wall 12b. More preferably the distal end 26 of the mold loose piece 16 becomes at least partially embedded in the opposing wall 12b. Preferably, the mold loose piece 16 is configured to create a secure joint with the opposing wall 12b. Achieving a secure joint between the mold loose piece 16 and the opposing wall 12b may be achieved via thermal bonding; adhesive bonding, as by an adhesive coating applied to the mold loose piece 16 prior to molding; or a mechanical lock, as created by a groove or hole in the distal end of the mold loose piece 16.

Furthermore, a joint may be secured between rib 14 and opposing wall 12b or between the ribs themselves by a post molding operation, via the use of heat (fusion bonding), ultrasonic vibration, radio frequency molding or induction welding (electromagnetic heating). In other words, mold loose piece 16 may be metallic, and under such circumstances, serve as the horn for the delivery of ultrasonic vibration, which would then facilitate the urging together and sealing of rib 14 to opposing wall 12b or to another rib section. In addition, mold loose piece 16 may itself contain a small protrusion which serves as an energy director on the surface of the plastic in the area to be bonded.

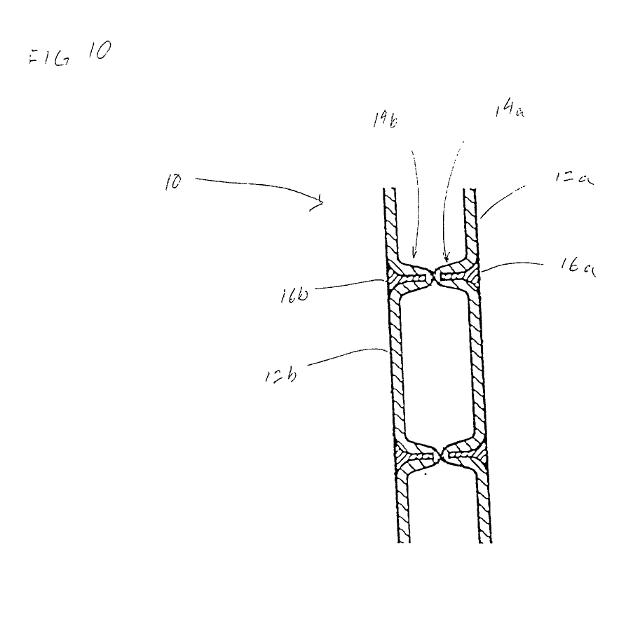

In an alternate embodiment, the container 10 may be partitioned or sectioned off by means of two opposed, inwardly projecting ribs 14a and 14b that join together. As illustrated in FIG. 9, preferably the partition comprises a first rib 14a comprising a wall portion 12a and a first mold loose piece 16a, wherein the distal end of the first rib 14a comprises a tongue feature 28. The partition additionally comprises a second rib 14b comprising a wall portion 12b and a second mold loose piece 16b, wherein the distal end of the second rib 14b comprises a groove feature 30. The interaction of the tongue feature 28 and the groove feature 30 forms a tongue and groove joint, therein stabilizing and aligning the joint of the two ribs 14a and 14b. Additionally, the tongue and groove joint enhances the strength of the joint. Alternately, the first rib 14a and the second rib 14b may be formed each having a flat or rounded distal end, and therein form a simple butt joint, as depicted in FIG. 10.

The incorporation of inwardly projecting ribs 14 into a blow molded container 10 may be used to a variety of advantageous ends. The application of ribs 14 to the container 10 provides an increase in the structural characteristics of the container 10. In the context of a pressurized coolant container, the added strength and stiffness resulting from the ribs 14 may allow the container to withstand greater pressures, attendant higher operating coolant temperatures, without having to increase the nominal wall thickness of the container.

The use of mold loose piece 16 to form an inwardly projecting rib 14 also effectively prevents thinning of the container wall 12 in the region of the rib 14. The thinned regions of the wall 12, resulting from the greater amount of stretch required to form the rib 14, are reinforced by the mold loose piece 16, therein eliminating weak spots. The reinforcing character of the mold loose piece 16 may allow a container 10 having inwardly projecting ribs 14 to be formed without necessitating parison programming to prevent areas of reduced wall cross-section at the ribs.

The added strength imparted on the container 10, and the localized regions of increased wall thickness corresponding to the mold loose piece 16 provides hard points on the container 10. The hard points in the container 10 facilitate, for example, through holes for the incorporation of plumbing the container 10, or mounting fixtures and screws. Furthermore, the solid nature of partitions in the container 10, stemming from the presence of the mold loose piece 16, allows holes to be introduced through the partition, therein allowing fluid communication between partitioned compartments, without compromising the integrity of the container 10 as a whole.

Additionally, inwardly projecting ribs 14 consistent with the present invention may provide a variety of application specific advantages. When ribs 14 according to the present invention are incorporated into the exemplary pressurized coolant container 10, the ribs may be employed in an appropriate configuration to allow the coolant to cascade over the ribs, encouraging de-aeration. Such de-aeration is critical to efficient operation of the cooling system, but is difficult to achieve economically in containers employing conventional manufacturing techniques.

While this invention has been disclosed and illustrated with reference to particular embodiments, the principles involved are susceptible for the use in numerous other embodiments. The invention is, therefore, not to be limited by the exemplary embodiments described in detail hereinabove, but only by the claims appended hereto.

What is claimed is:

1. A blow molded article comprising an inwardly projecting rib and a mold loose piece, said inwardly projecting rib comprising a wall portion formed around said inwardly projecting mold loose piece.

2. The blow molded article according to claim 1, wherein said blow molded article comprises a first and second wall portion, each wall portion containing an interior and exterior surface, and wherein said inwardly projecting rib formed around said inwardly projecting mold loose piece is located in said first wall portion and said rib contacts the interior surface of a second wall portion.

3. The blow molded article according to claim 2, wherein said mold loose piece in said first wall portion contacts the interior surface of said second wall portion.

4. The blow molded article according to claim 1 comprising a plurality of inwardly projecting ribs comprising wall portions formed around a plurality of inwardly projecting mold loose pieces.

5. The blow molded article of claim 4, wherein at least one of said plurality of inwardly projecting ribs contact one another.

6. The blow molded article according to claim 4, wherein two of said plurality of inwardly projecting ribs comprise a tongue and groove connection which engage one another.

7. The blow molded article according to claim 1, wherein said mold loose piece is fused to a portion of the wall.

8. The blow molded article according to claim 1 further comprising an adhesive disposed between said mold loose piece and said wall.

9. The blow molded article according to claim 8, wherein said adhesive is a heat activated adhesive.

10. The blow molded article according to claim 8, wherein said adhesive is a pressure sensitive adhesive.

11. The blow molded article according to claim 8 wherein said adhesive is a layer of thermoplastic film.

12. The blow molded article according to claim 1 wherein said mold loose piece comprises a mechanical lock feature retaining said mold loose piece to said wall portion

13. The blow molded article according to claim 12 wherein said mechanical lock feature comprises a blind hole.

14. The blow molded article according to claim 12 wherein said mechanical lock feature comprises a through hole.

15. The blow molded article according to claim 12 wherein said mechanical lock feature comprises surface roughening.

16. The blow molded article according to claim 12 wherein said mechanical lock feature comprises a groove.

17. The blow molded article according to claim 1 wherein said mold loose piece comprises a solid member.

18. The blow molded article according to claim 1 wherein said mold loose piece comprises a hollow member.

19. The blow molded article according to claim 1, wherein said mold loose piece contains an exterior surface and said exterior surface contains a recess.

20. The blow molded article according to claim 1 wherein said mold loose piece comprises a metallic member.

21. The blow molded article according to claim 1 wherein said mold loose piece comprises a plastic material.

22. The blow molded article according to claim 21, wherein said mold loose piece comprises the same plastic material as said wall.

23. A method for forming a blow molded article having at least one inwardly projecting rib, the method comprising the steps of:
providing a mold having a cavity defined therein by a cavity wall;
providing a mold loose piece disposed on the cavity wall;
introducing a parison into said cavity;
introducing said mold loose piece into said parison.

24. The method of claim 23, including the step of inflating said parison, whereby said parison conforms to said cavity and said mold loose piece.

25. The method according to claim 22, wherein said mold contains a moving component and said mold loose piece is disposed on said moving component and said moving component moves said mold loose piece into said parison.

26. The method according to claim 23 further comprising supplying an adhesive to said mold loose piece prior to introducing said loose piece into said parison.

27. The method according to claim 23 further comprising supplying said mold loose piece with a mechanical lock to lock said mold loose piece to said parison.

28. The method according to claim 23, wherein said mold loose piece is heated.

29. The method of claim 28, wherein said mold loose piece is heated to a temperature at or above that of said parison.

30. The method of claim 23 wherein said mold loose piece is metallic and said metallic loose piece is subjected to ultrasonic vibration, radio frequency welding or induction welding.
